(19) United States
(12) Patent Application Publication
(10) Pub. No.: US 2025/0085078 A1
(43) Pub. Date: Mar. 13, 2025

(54) RATCHET LOADED SPEARGUN

(71) Applicant: Caleb Juyoung Kim, Austin, TX (US)

(72) Inventor: Caleb Juyoung Kim, Austin, TX (US)

(21) Appl. No.: 18/825,886

(22) Filed: Sep. 5, 2024

Related U.S. Application Data
(60) Provisional application No. 63/581,159, filed on Sep. 7, 2023.

(51) Int. Cl. F41B 7/04; A01K 81/06; F41B 7/00; F41B 11/83

(52) U.S. Cl. CPC F41B 7/04; A01K 81/06; F41B 7/003; F41B 11/83

(57) ABSTRACT

A speargun having ratchet mounted to or integrated into the stock of the speargun to aids in the stretching of the elastic bands to load the speargun. The ratchet is connected to the elastic bands and allows a user to stretch the elastic bands to load the speargun incrementally instead of all at once. The ability to incrementally load the power using a ratchet not only makes it easier to load the speargun, but also enables the same speargun to be used for a variety of spearfishing applications where different amounts of force are optimal to propel the spear.

### CROSS-REFERENCE TO RELATED APPLICATIONS

This application claims priority from U.S. Provisional Application No. 62/753,253 filed Sep. 7, 2023, and titled “RATCHET LOADED SPEARGUN,” a copy of which is incorporated in its entirety.

### FIELD OF THE DISCLOSURE

This present disclosure is in the field of spearguns, primarily used in sportfishing, and the devices used for aiding in the loading of spearguns.

### BACKGROUND

Spearfishing, a form of underwater hunting with ancient roots, has evolved significantly since its early practices. Initially, spearfishing was conducted with simple hand-held spears or harpoons, which required great skill and strength from the fisherman. The sport gained modern prominence in the early 20th century, particularly with the introduction of specialized equipment that enhanced its effectiveness. By the mid-1930s, the invention of the speargun marked a significant technological advancement, allowing for more precise and efficient underwater hunting. Many different types of spearguns exist today, such as elastic band powered guns, pneumatic compressed air powered spearguns, and variations and combinations of these that have different advantages and disadvantages. It is a sport enjoyed by many people all around the world and has gained popularity in recent years.

Most spearfishing today is done using standard elastic band powered spearguns as shown in FIG. 3, which typically consists of:
1. A wooden, metal, or composite stock (301) that has a groove down the middle that serves as a track or rail that aligns and guides the spear projectile,
2. a long thin metal cylindrical spear projectile (302) that is sharp on one end with a “flopper” barb (303) which allows the spear to stay in the fish without backing out, and the other end of the spear which has two sets of notches where one set (304) is used to connect the elastic bands onto the spear to propel it, and the other set of notches locks the spear into a trigger mechanism,
3. a trigger mechanism that locks the spear in place and releases the spear when the trigger (305) is pulled allowing the spear to shoot out as a projectile, and
4. elastic bands (306) that are anchored to the front of the stock, or the “head” (307) of the stock, which are pulled from front to back of the stock, and hooked onto the notches (304) on the back of the spear to load the spear with force.

A variation of the standard elastic band speargun described above which is also commonly used is called a “roller speargun” as shown in FIG. 2. This type of speargun anchors the elastic bands (201) under the stock (202) towards the rear of the speargun, wraps around a set of rollers (203), which are a set of small wheels on the front of the stock, around to the top of the stock and stretched back onto the notches (204) on the spear (205) at the rear of the speargun to load it. Because of the way the band is routed around the spear gun, roller spearguns stretch the elastic band a longer distance, approximately 2× the length of the stock, versus just 1× the length of the stock as in standard elastic band spearguns. Due to this, when the spear is released, the elastic band pulls with a higher force as well as through the entire length of the speargun. In a standard speargun (FIG. 3) where the elastic bands are anchored to the front of the speargun, the bands will lose all of its tension before the entire length of the gun, therefore it does not take advantage of the full length of the stock. The “roller speargun” shown in FIG. 2 has the advantage of being more compact and shorter, with equivalent power to longer spearguns.

Whether it is a standard speargun (FIG. 3) or roller speargun (FIG. 2), they are both loaded by placing the butt of the stock (206) on either the chest or the thigh, and pulling the elastic bands (201) back toward the notch (204) on the spear near the back of the speargun. This requires the user to exert approximately ˜50 to ˜150 pounds of force per band, depending on the size of the gun. The amount of force required varies depending on how long the elastic band must be stretched and the type of elastic used in the band. Longer guns requiring a longer stretching of the bands, will need more force to load than shorter spearguns. The amount of force required makes using spearguns difficult to use, and longer and more powerful guns are often too difficult to use for most people. Some spearguns use multiple bands of lesser force to have a higher total force propelling the spear. The overall loading process can cause bruising, misfires, muscle fatigue/cramping, resulting in many people being unable to load guns or just not enjoying the experience.

Since both of these guns are so difficult to load, devices such as chest pads and load assist bands are employed for both roller and non-roller guns. Chest pads reduce bruising and make loading a speargun less painful by using a material that can cushion the butt of the gun against the chest. These are typically built into the front chest area of wetsuits or they can be strapped on as a separate accessory. Load assist bands are smaller circular sections of elastic bands with hooks to attach to the elastic bands of the speargun and make the gun much easier to load by breaking up the loading process into two steps instead of one. The load assist band, once hooked onto the elastic band, is pulled back and hooked onto the notch of the spear. This requires less force because the bands are not stretched as much in a single step. Once the load assist band is in place, the elastic bands are pulled back, the load assist band is removed, and the elastic bands are pulled back the rest of the way and hooked onto the notch in the spear. While these solutions can help alleviate the problem of loading spearguns, using additional devices can complicate the loading process and require additional accessories that must be managed while swimming in the ocean. At the end of the day, the user still needs to be able to pull the elastic bands back using any of the devices out on the market today.

Elastic band powered spearguns also have limited abilities to change the amount of power their guns have. The only way to modify the amount of power would be through the use of more or less bands, shortening or lengthening the bands, using a band with a different tensile strength, or using a gun with a longer stock that can stretch the bands farther. None of these options can be done while using the speargun out in the field, and must be modified or changed prior to use. Because it is difficult to adjust the power of a speargun on the fly, oftentimes one speargun will not be adequate for more than one situation because it is either too powerful or not powerful enough.

For example, when a spear fisherman is in a coral reef but has a high-powered gun, the gun will not be able to shoot because the shaft will get stuck into a coral head, bend, or break. Likewise, if a spear fisherman has a low powered gun and is trying to shoot a large gamefish at a long distance, the gun will have neither the range to reach the fish, nor the power to penetrate and kill the fish. The versatility of spearguns and the strength needed to load them are both major drawbacks of the sport and make spearfishing difficult for many potential users of spearguns.

### SUMMARY OF THE DISCLOSURE

Embodiments of the disclosure include the integration of a ratchet onto a speargun to aid in loading of force, used to propel a spear projectile, onto a speargun incrementally for an easier and controlled loading process. Embodiments of the disclosure include a ratchet and different types of spearguns such as pneumatic/compressed air powered and elastic band powered spearguns. The embodiments described herein are elastic band powered spearguns, but other embodiments may include other types of spearguns known to those skilled in the art.

In an elastic band powered speargun, the stretching of the elastic band provides the force needed to launch the spear projectile, much like a slingshot. However, the elastic bands are difficult to stretch because of the amount of force needed, ranging from 50 pounds to over 150 lbs per band. By using a ratchet, the elastic bands can be stretched incrementally with a mechanical advantage, rather than having to stretch it all at once by hand, making it much easier to load the speargun. The incorporation of a ratchet further allows for variable power loading, making the speargun much more versatile for many different situations.

One embodiment of the disclosure includes the incorporation of a roller type elastic band speargun with a rotary ratchet connected to the elastic bands to help stretch and load a speargun as shown in FIG. 1. A second embodiment of the disclosure includes the incorporation of a roller type elastic band speargun with a linear ratchet connected to the elastic bands to help stretch and load the speargun as shown in FIG. 4. A third embodiment of the disclosure incorporates a linear ratchet onto a standard elastic band powered speargun as shown in FIG. 5. The concept of using a ratchet can be expanded to other types of elastic band powered spearguns, as well as other types of spearguns such as pneumatic/compressed air spearguns. Advantageously, embodiments of the disclosure may use any suitable commercially available ratchets.

### BRIEF DESCRIPTION OF THE DRAWINGS

In the following detailed portion of the present description, the teachings of the present application will be explained in more detail with reference to the example embodiments shown in the drawings, in which:

FIG. 1 is a side view of the first embodiment of the disclosure using a rotary ratchet on a roller type speargun using elastic bands;

FIG. 2 is a side view of a prior art roller type elastic band speargun that is already available on the market;

FIG. 3 is a side view of a prior art standard elastic band speargun that is also available on the market;

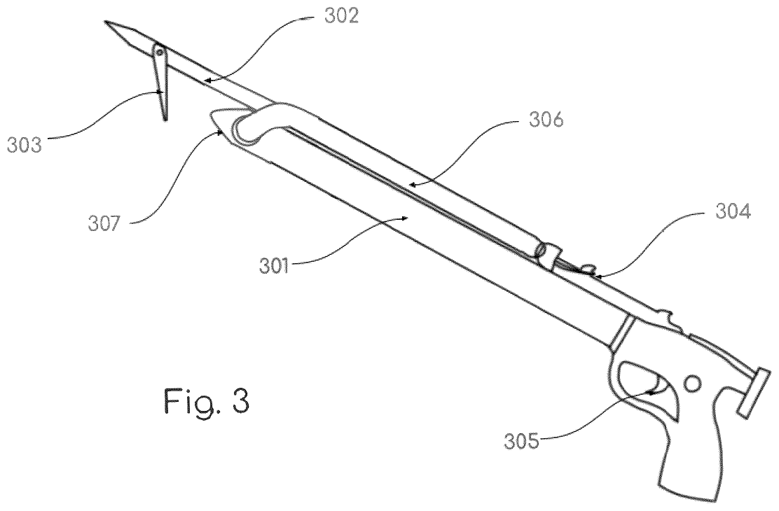

FIG. 4 is a side view of an embodiment of the disclosure using a linear ratchet on a roller type elastic band speargun using elastic bands; and

FIG. 5 is a side view of an embodiment of the disclosure using a linear ratchet on a standard elastic band type speargun.

### DETAILED DESCRIPTION OF THE DISCLOSURE

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those define in commonly used dictionaries, should be interpreted as having a meaning that is consistent with their meaning in the context of the relevant art and the present disclosure and will not be interpreted in an idealized or overly formal sense unless expressly so defined herein.

It will be understood that a number of techniques and steps are described in the disclosure. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the disclosure and the claims.

A new type of speargun devices, apparatuses, and methods of loading and using the speargun are described herein. In the following descriptions, for purposes of explanation, numerous specific details are set forth in order to provide a thorough understanding of the present disclosure. It will be evident, however, to one skilled in the art, that the present disclosure may be practiced without these specific details. Embodiments described herein are to be considered as examples and are not intended to limit the disclosure to specific embodiments illustrated by the figures or description below.

Embodiments of the disclosure include an integrated ratchet for spearguns of all types including but not limited to pneumatic guns, elastic band powered guns, spring loaded guns, roller guns, hybrid standard roller guns, inverted roller guns, as well as other devices used to propel a spear. By way of example, the ratchet may include a linear bar or rotary wheel, with a set of unidirectional angled teeth in which a pawl or tooth engages allowing motion in one direction only unless the engagement of the pawl or tooth is disengaged. Both linear (using a bar of unidirectional angled teeth) and rotary (using a wheel of unidirectional angled teeth) ratchets are discussed in this disclosure, but embodiments may include other ratchets that restrict the motion in one direction until released and their incorporation with a suitable type of speargun.

The incorporation of a ratchet gives the user the ability to load the speargun much more easily by using unidirectional notches and/or teeth in the ratchet to lock the bands in position where they cannot release unless the user of the speargun manually releases the ratcheting mechanism. The speargun can be loaded incrementally, a little at a time, resting in between increments if necessary. Some ratchets include a mechanical advantage, further decreasing the amount of energy and force required to load the speargun.

The ratchet additionally gives the user the ability to load the speargun with a desired amount of force depending on the situation. By using the ratchet to fully stretch the elastic band, they would get the most power out of the gun. By ratcheting less than the full distance, they would not fully stretch the band and would get less power. The notches on the ratchet give the ability to discreetly choose how much to stretch the band and thereby the amount of power the spear will have when it is shot out of the speargun. Since the speargun can be shot at any position of the ratchet, it is possible to vary the power using the ratchet. The ratchet can also be mounted anywhere on the speargun's stock, on the bottom, sides, top, front, and back. Any material able to withstand the loads imparted on the speargun can be used as the stock, such as but not limited to wood, metals, metal alloys, rubber, plastics, carbon fibers, fiberglass, carbon fiber composites, composites, and so on.

Since the ratchet adds weight to the speargun, in order to counterbalance the added weight of the gun, in some embodiments the stock may be made of a buoyant material. In some embodiments, the stock could also be made buoyant in specific locations, such as on the opposite end of the stock from where the ratchet is mounted to counterbalance the ratchet, making it easier to aim and hold out with extended arms while used in the ocean or other bodies of water.

In some embodiments, the ratchet may be motorized such that the ratchet actuation is powered by electricity or other sources.

The materials used in the ratcheting speargun, including the stock, trigger mechanisms, bands, and other components, may include any material strong enough to withstand the forces induced upon it and resistant to exposure to the elements. The materials can also be specifically corrosion resistant against moisture and salt water from the ocean, but proper sealing of components to protect it from the environment can mitigate the damage resulting from this type of degradation. These materials include but are not limited to woods, metals, metal alloys, rubbers, plastics, polymers, resins, epoxies, fiberglass, carbon fiber, carbon fiber composites, and other composites and combinations of the materials listed. Coatings and surface treatments can also be used such as metal plating, coated metals, painted metals, corrosion resistant treatments, and other combinations thereof.

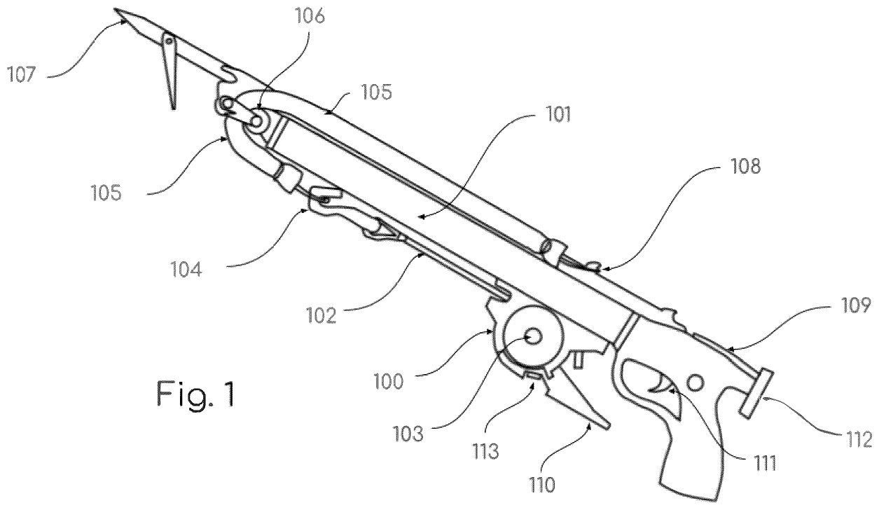

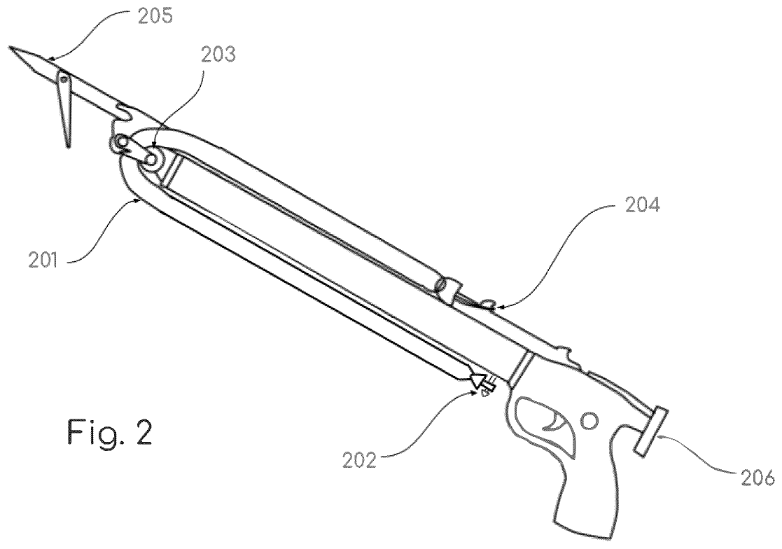

An embodiment of this disclosure is shown in FIG. 1, where a rotary ratchet (100) has been mounted to the underside of the stock (101) of a roller type of speargun, using elastic bands (105) as discussed previously in the Background and shown in FIG. 2. It should be noted that the ratchet (100) does not have to be mounted on the bottom and can be mounted on the sides of the gun or in different locations along the stock (101). The rotary ratchet (100) has a lever (110), which is pressed up and down around the center axis by hand to actuate the ratchet and allow for the strap (102) to be wound into the spool (103) of the rotary ratchet (100).

As shown in FIG. 1, the strap (102) is connected by a hook (104) to the elastic bands (105) of the spear gun on the bottom side of the stock (101). The hook (104) can be made of any hard durable material strong enough to withstand the forces exerted on it by the elastic bands and the ratchet. Other embodiments may include other components to attach the strap (102) to the elastic bands (104). For example, the strap can be permanently sewed around the elastic bands, or a carabiner can be used. In some embodiments, the hook (104) and strap (102) may be entirely omitted, and the elastic bands (105) can be directly connected to the ratcheting mechanism. The elastic bands (105) are routed through the rollers (106) around the front end of the speargun, to the top side of the speargun, and hooked onto the notch (108) located on the back of the spear projectile (107). The spear projectile (107) is fixed in place and cannot shoot out of the speargun until the trigger (111) opens the latch (109) and releases the spear projectile. The trigger mechanisms (111) and latches (109) to hold the spear projectile (107) in place are all well known in the industry and any number specific trigger and latch mechanisms can be used.

With the spear projectile (107) locked into place and the elastic bands (105) connected to the notch (108) on the top of the spear projectile, one side of the elastic bands (105) are now fixed in place. The other side of the elastic bands (105) are connected to the strap (102) on the bottom of the speargun, when the ratchet is incremented by pushing the lever (110) up and down, the strap starts to wind into the spool (103), and pulls the elastic bands (105) back towards the ratchet, thereby stretching the elastic band (105). As the ratchet is advanced and more of the strap (102) is wound up in the spool (103) of the ratchet, the elastic bands (105) are elongated and stretched, putting more and more force on the notch (108) on the spear projectile (107). The strap can be either a flat ribbon type or a rope type and can be made of any materials that are able to withstand the load induced upon it such as fibers, polymers, metals, composites, and so forth.

Although not explicitly illustrated in the figure, a display or gauge or indicator can also be integrated into the ratchet that shows the amount of tension and force on the elastic bands depending on the amount the ratchet has been advanced. This can easily be done with a simple mark on the side of the wheel or it can be more complex with tick marks displaying the amount of force based on the amount of rotation of the ratchet corresponding to the amount of stretch in the elastic bands.

The trigger (111) can be pressed at any point in the ratcheting process to release and thereby launch the spear projectile (107) depending on how much force is desired. For full force, the ratchet would be advanced as far as possible, giving the elastic bands (105) the maximum amount of stretch. If the straps were connected directly to the elastic bands (105) without the hook (104), it is possible to even start winding the elastic bands (105) into the spool (103) for even more stretching of the bands and therefore more power exerted on the spear projectile (107).

There can also be a release button (113) that lifts the locking pawl away from the toothed gear to allow the ratchet to freely spin in either direction. This can be useful if the tension in the elastic bands needs to be released without firing the spear projectile (107).

In some embodiments, the ratchet may include the type as described in U.S. Pat. No. 7,503,736, titled “Retractable tie-down with rotation brake” and issued Mar. 17, 2009, a copy of which is incorporated by reference. In other embodiments, other ratchets can similarly be used to achieve the same function. Moreover, the ratchet depicted in FIG. 1 is only a basic depiction and does not exclude other ratchet types that have automatically retracting ratchets, locking and unlocking properties, or any other settings that may be included in a ratchet's design.

In other embodiments, the ratchet may be advanced using different mechanisms and does need to be configured to use the lever (110) shown in FIG. 1. For example, the ratchet could include a hand crank style similar to a fishing reel positioned to the side of the ratchet. This can give the user more mechanical advantage to ease the advancing of the ratchet to stretch the elastic bands. The ratchet could also be powered electrically with a battery and motor that turns the toothed gear.

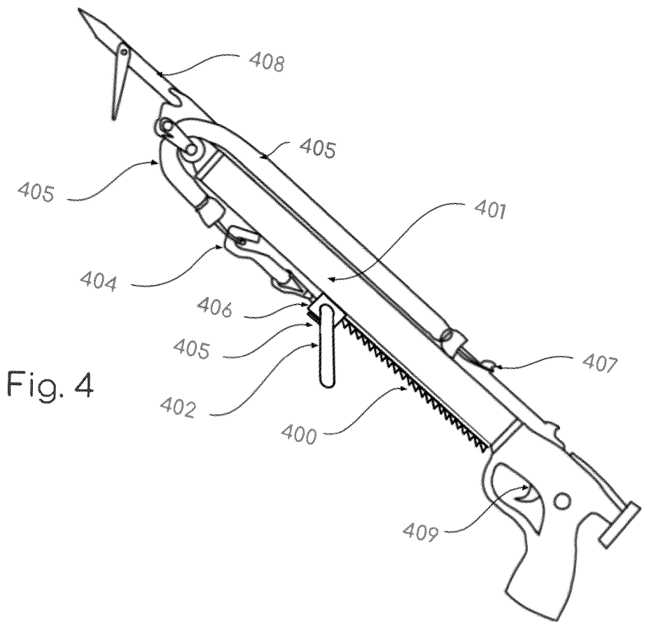

Another embodiment of the ratcheting speargun may use a linear ratchet as shown in FIG. 4, where the toothed gear (400) is no longer on a wheel, but rather a bar that is attached to the stock (401) of a roller type speargun. The spring-loaded pawl of the ratchet is in a housing (406) that sits on the linear gear, and engages with the teeth of the gear allowing movement in only one direction (towards the back of the speargun) unless a release button (405) is pressed which disengages the pawl from the teeth allowing free movement of the ratchet housing (406). The ratchet is connected to the elastic bands (405) by a hook (404), but can be any number of other components such as a carabiner or simply just a loop of strap or the elastic bands (405) can be mounted directly onto the housing (406). A handle bar (402) can be used to pull the ratchet (406) back to stretch the elastic bands (405) to load the speargun. The elastic bands are stretched and loads force onto the spear projectile (408) because they are constrained on one side by the notches (407) on the spear projectile (408), and are pulled by a hook (404) attached to the ratchet on the other side. The handle bar (402) can be in a variety of form factors, such as rings, handles, and so on, to facilitate pulling the elastic bands back by advancing the ratchet and housing (406) along the rails of the linear gear. When the elastic bands are stretched to a desired level, the trigger (409) can be pressed, thereby releasing the spear projectile (408) and allowing the elastic bands (405) to pull the spear and fire it out of the speargun. Similar to the other embodiments, the ratchet allows for variable loading of force on the elastic bands (405) since the spear projectile (408) can be fired from any position of the ratchet. The elastic bands (405) have multiple stretch lengths and therefore amounts of force it can use to fire the spear projectile (407) due to the locking nature of the ratchet.

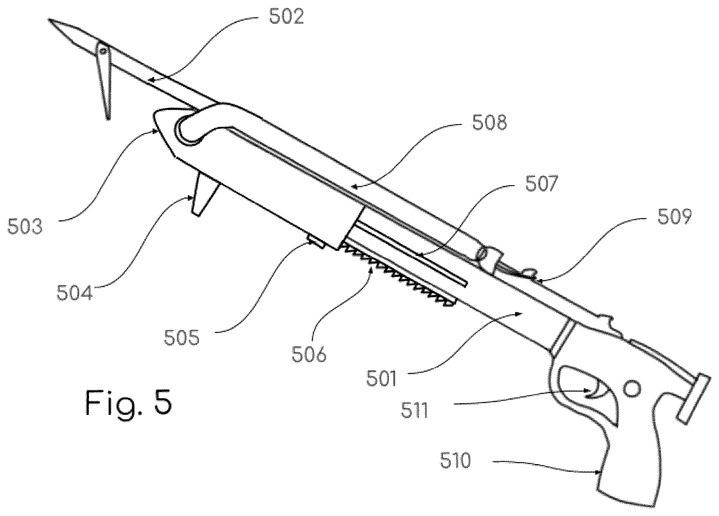

Another embodiment of a speargun using a linear geared ratchet incorporated into a standard elastic band speargun is shown in FIG. 5. In this embodiment, the front of the stock (503) that anchors the elastic bands (508) can slide back and forth along the main stock (501) guided by a rail (507) to prevent rotational movement around the stock (501). A linear toothed gear (506) and a spring-loaded pawl engages the teeth of the gear to allow for motion only in the direction that elongates the overall length of the stock. Elongation of the stock in this embodiment stretches and loads the elastic bands (508) because the bands are anchored on one side by the front of the stock (503) and on the other side by the notches in the spear (509). The spring-loaded pawl can be located just underneath a release button (505) that when depressed, disengages the spring-loaded pawl and allows for the free movement of the front of the stock (503) thereby allowing for decreasing the length of the stock and unloading or relaxation of the elastic bands (508). The details of the spring-loaded pawl and the ratchet may be implemented according to techniques known in the art.

In this embodiment, an extrusion (504) can be used as a handle or foothold as a leverage point to expand the length of the speargun to stretch and load the elastic bands (508). The extrusion (504) can take many different form factors, sizes, and shapes, and can be placed in any number of locations on the front of the stock (503). The extrusion (504) may allow the user to have a leveraging point to exert force on the front of the stock (503). As the front of the stock (503) is pressed outward, away from the handle (510), the elastic bands (508) are stretched and the ratchet advances and engages to prevent the contraction of the elastic bands (508). Similar to the rotary ratchet discussed, this can allow for variable loading of the force on the spear gun, meaning the speargun can be fired with different amounts of force depending on how far the elastic bands are stretched. The extrusion (504) can be leveraged by holding onto the handle of the speargun (510) with the hands and placing a foot on the extrusion (504) and pressing with the foot to elongate the length of the stock and stretch the elastic bands (508), thereby making it easier to load the speargun by using stronger leg muscles in the body. With the elastic bands (508) stretched to the desired point, when the trigger (511) is pressed, the spear projectile (502) is no longer locked into the latch and is allowed to be released, thereby allowing the elastic bands (508) to contract and pull the spear projectile (502) along the rail of the stock (501), and launching it out of the gun.

What is claimed is:

1. A speargun comprising:
a spear projectile;
a stock comprising a groove for guiding the spear projectile;
a trigger coupled to the stock; and
a ratchet that allows for the incremental loading of force to propel the spear projectile upon actuation of the trigger.

2. The speargun of claim 1, comprising elastic bands arranged to propel the spear projectile.

3. The speargun of claim 2, wherein the stock comprises a set of rollers positioned at the front of the stock, wherein the elastic bands are routed around the set of rollers and are anchored to the underside of the stock.

4. The speargun of claim 1, wherein the ratchet comprises a rotary ratchet that comprising a wheel with angled teeth operable to engage a pawl, such that the rotary ratchet only allows motion in one direction until the pawl is disengaged from the wheel.

5. The speargun of claim 4, wherein the speargun comprises a roller type elastic band speargun, wherein the rotary ratchet is mounted onto the roller type elastic band speargun to facilitate the stretching of elastic bands and loading of the roller type elastic band speargun.

6. The speargun of claim 1, wherein the ratchet is a linear ratchet comprising a set of angled teeth arranged in a linear fashion and operable to engage a pinion, such that the linear ratchet only allows motion in one direction until the pinion is disengaged from the linear row of angled teeth.

7. The speargun of claim 6, wherein the speargun comprises a roller type elastic band speargun, wherein the linear ratchet is mounted onto the roller type elastic band speargun to facilitate the stretching of elastic bands for loading of the roller type elastic band speargun.

8. The speargun of claim 6, wherein the speargun comprises a standard elastic band speargun, wherein the linear ratchet is mounted onto the standard elastic band speargun to facilitate the stretching of elastic bands for loading of the standard elastic band speargun.

9. The speargun of claim 8, comprising a leverage point, the leverage point positioned on a front of the stock, such that the leverage point may receive a foot to provide an opposite force for stretching the elastic bands.

10. The speargun of claim 1, comprising a gauge configure to display an amount of force loaded onto the spear projectile.

11. The speargun of claim 2, wherein the ratchet is mounted in a position to maintain the elastic bands adjacent to and in a direction substantially parallel with the stock.

12. The speargun of claim 1, wherein the ratchet is mounted in a position that enables another component to be mounted to the stock without interfering with the operation of the ratchet.

13. The speargun of claim 1 wherein the stock comprises a buoyant material.

14. The speargun of claim 13, wherein an amount of the buoyant material is selected to counterbalance a weight of the ratchet.

15. The speargun of claim 1, wherein the stock, trigger, spear projectile, and ratchet are formed from a corrosion-resistant material.

16. The speargun of claim 1. where the ratchet is powered by an electrical motor.

17. The speargun of claim 1, comprising a lever operable to actuate the ratchet.

18. The speargun of claim 1, wherein the speargun comprises a pneumatic type speargun configured to use pressurized gas to propel the spear projectile.
